(19) United States
(12) Patent Application Publication
(10) Pub. No.: US 2015/0062426 A1
(43) Pub. Date: Mar. 5, 2015

(54) METHOD AND APPARATUS FOR CONNECTING TV SET TO WIFI

(71) Applicants: Yong LU, Beijing (CN); Yingbiao PENG, Shanghai (CN)

(72) Inventor: Yong LU, Beijing (CN)

(21) Appl. No.: 14/535,564

(22) Filed: Nov. 7, 2014

Related U.S. Application Data
(63) Continuation of application No. PCT/CN2013/074281, filed on Apr. 17, 2013.

(30) Foreign Application Priority Data
May 9, 2012 (CN) 201210143703.0

(51) Int. Cl. H04N 21/4363; H04N 21/436; H04N 21/41; H04N 5/44; H04N 7/01

(52) U.S. Cl. CPC H04N 21/43637; H04N 5/44; H04N 7/01; H04N 21/43635; H04N 21/4126; H04N 21/43615
USPC 348/441

(57) ABSTRACT

A method for connecting a TV set to WiFi comprises: receiving a WiFi signal comprising an audio/video signal sent by a WiFi apparatus; obtaining the audio/video signal in the WiFi signal; converting the audio/video signal into an audio/video signal in a TV playing format; and sending the converted audio/video signal in the TV playing format to a TV set. An apparatus for connecting a TV set to WiFi comprises: a WiFi communication unit for receiving a WiFi signal comprising an audio/video signal sent by a WiFi apparatus; an embedded-type computer chip for obtaining the audio/video signal in the WiFi signal; an audio/video circuit unit matching with a TV signal, for converting the audio/video signal into an audio/video signal in a TV playing format; and a TV audio/video signal output unit for sending the converted audio/video signal in the TV playing format to the TV set.

This application is a continuation of International Application No. PCT/CN2013/074281, filed on Apr. 17, 2013, which claims priority to Chinese Patent Application 201210143703.0, filed on May 9, 2012, both of which are hereby incorporated by reference in their entireties.

### TECHNICAL FILED

The present invention relates to the technical fields of wireless communication, especially to a method and apparatus for connecting a TV set to WiFi.

### BACKGROUND

With continuous applications and developments of the network technology and the computer technology, one-to-one file transfer including file information has been widely applied in daily work and daily life. Various trans-sight video devices are sustaining innovations. However, in terms of the current market, there is everything except a tool and apparatus for integrating such devices.

In the prior art, for example, when a mobile phone is connected to a TV set, it requires that the mobile phone must have an audio/video output ability. However, not all devices has the audio/video output ability, so there is a need for an apparatus for integrating all video devices and intelligent devices such as computers, thereby constituting a video platform at home and in an office environment, so as to achieve video resource sharing.

### SUMMARY

The embodiments of the invention provides a method and apparatus for connecting a TV set to WiFi, in order to make the display contents of various video terminals all connect to the TV set for display, thereby increasing the use function of the video terminals to a maximum extent.

In one aspect, the embodiment of the present application provides a method for connecting a TV set to WiFi comprising:

receiving a WiFi signal sent by a WiFi apparatus, the WiFi signal comprising an audio/video signal;

obtaining the audio/video signal in the WiFi signal according to the WiFi signal;

converting the audio/video signal into an audio/video signal in a TV playing format; and

sending the converted audio/video signal in the TV playing format to the TV set.

Alternatively, in one embodiment of the present invention, the WiFi apparatus comprises a WiFi router and an intelligent terminal; the WiFi signal further comprises a password, the method further comprises: judging, according to the password, whether the audio/video signal is to be sent to an apparatus for performing the method.

Alternatively, in one embodiment of the present invention, the obtaining the audio/video signal in the WiFi signal according to the WiFi signal comprises: obtaining the audio/video signal in the WiFi signal by using a high-pass/low-pass filter according to the WiFi signal.

Alternatively, in one embodiment of the present invention, the audio/video signal in the TV playing format comprises an audio/video signal extracted by half-wave rectification; the sending the converted audio/video signal in the TV playing format to the TV set comprises: coupling the extracted audio/video signal to left and right channels and video input terminals of the TV set through a rubber plug, or sending the extracted audio/video signal to the TV set by using a standard video interface and an HDMI interface.

Alternatively, in one embodiment of the present invention, the audio/video signal in the TV playing format comprises an audio/video carrier signal played by TV, which is loaded and modulated according to a television system; the sending the converted audio/video signal in the TV playing format to the TV set comprises: inserting the audio/video carrier signal into an antenna signal receiving terminal of the TV set, so as to send the converted audio/video carrier signal to the TV set.

In another aspect, the embodiment of the present application provides an apparatus for connecting a TV set to WiFi comprising:

a WiFi communication unit for receiving a WiFi signal sent by a WiFi apparatus, the WiFi signal comprising an audio/video signal;

an embedded-type computer chip for obtaining the audio/video signal in the WiFi signal according to the WiFi signal;

an audio/video circuit unit matching with a TV signal, for converting the audio/video signal into an audio/video signal in a TV playing format; and

a TV audio/video signal output unit for sending the converted audio/video signal in the TV playing format to the TV set.

Alternatively, in one embodiment of the present invention, the WiFi apparatus comprises a WiFi router and an intelligent terminal; the WiFi signal further comprises a password, the embedded-type computer chip is further adapted to judge, according to the password, whether the audio/video signal is to be sent to the apparatus.

Alternatively, in one embodiment of the present invention, the embedded-type computer chip is adapted to obtain the audio/video signal in the WiFi signal by using a high-pass/low-pass filter according to the WiFi signal.

Alternatively, in one embodiment of the present invention, the audio/video signal in the TV playing format comprises an audio/video signal extracted by half-wave rectification; the TV audio/video signal output unit comprises a first TV audio/video signal output module for coupling the extracted audio/video signal to left and right channels and video input terminals of the TV set through a rubber plug, or sending the extracted audio/video signal to the TV set by using a standard video interface and an HDMI interface.

Alternatively, in one embodiment of the present invention, the audio/video signal in the TV playing format comprises an audio/video carrier signal played by TV, which is loaded and modulated according to a television system; and the TV audio/video signal output unit comprises a second TV audio/video signal output module for inserting the audio/video carrier signal into a antenna signal receiving terminal of the TV set, so as to send the converted audio/video carrier signal to the TV set.

The above technical solutions have the following advantageous effect that it is possible to make the display contents of various video terminals all connect to a TV set for display, thereby increasing the use function of the video terminals to a maximum extent, due of the adoption of the technical means of receiving a WiFi signal sent by a WiFi apparatus, the WiFi signal comprising an audio/video signal; obtaining the audio/video signal in the WiFi signal according to the WiFi signal; converting the audio/video signal into an audio/video signal in a TV playing format; and sending the converted audio/video signal in the TV playing format to a TV set.

### BRIEF DESCRIPTION OF THE DRAWINGS

In order to more clearly describe the embodiments of the present invention or the technical solutions of the prior art, the drawings to be used in the descriptions of the embodiments or the prior art are briefly introduced as follows. Obviously, the following drawings just illustrate some embodiments of the present invention, and a person skilled in the art can obtain other drawings from these drawings without paying any creative effort.

FIG. 1 is a flowchart of the method for connecting a TV set to WiFi according to the embodiments of the present invention;

FIG. 2 is a structural diagram of the apparatus for connecting a TV set to WiFi according to the embodiments of the present invention;

FIG. 3 is a structural diagram of a TV audio/video signal output unit according to the embodiments of the present invention;

FIG. 4 is a diagram of connecting the apparatus for connecting a TV set to WiFi with the TV set according to examples of application of the present invention;

FIG. 5 is a diagram of connecting the apparatus for connecting a TV set to WiFi with a WiFi router according to examples of application of the present invention;

FIG. 6 is a diagram of constitutional structure of the apparatus for connecting a TV set to WiFi according to examples of application of the present invention;

FIG. 7 is a logic circuit schematic diagram of the audio/video circuit matching with TV signal according to examples of application of the present invention;

FIG. 8 is an operational flow diagram of the apparatus for connecting a TV set to WiFi according to examples of application of the present invention; and

FIG. 9 is a diagram of a network architecture formed by the apparatus for connecting a TV set to WiFi through a WiFi router according to examples of application of the present invention.

### DETAILED DESCRIPTION OF THE EMBODIMENTS

The technical solutions in the embodiments of the present invention will be clearly and completely described below in combination with the drawings in the embodiments of the present invention. Obviously, those described herein are just parts of the embodiments of the present invention rather than all the embodiments. Based on the embodiments of the present invention, any other embodiment obtained by a person skilled in the art without paying any creative effort shall fall within the protection scope of the present invention.

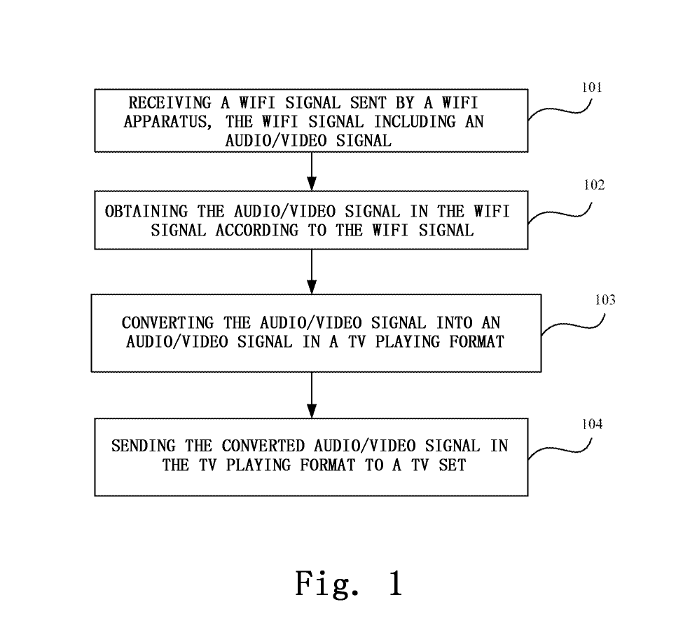

As shown in FIG. 1 which is a flowchart of a method for connecting a TV set to WiFi according to the embodiments of the present invention, the method for connecting a TV set to WiFi includes:

101. receiving a WiFi signal sent by a WiFi apparatus, the WiFi signal including an audio/video signal;

102. obtaining the audio/video signal in the WiFi signal according to the WiFi signal;

103. converting the audio/video signal into an audio/video signal in a TV playing format; and

104. sending the converted audio/video signal in the TV playing format to a TV set.

Alternatively, the WiFi apparatus includes a WiFi router and various intelligent terminals; the WiFi signal further includes a password, the method further includes:

judging, according to the password, whether the audio/video signal is to be sent to an apparatus for performing the method.

Alternatively, the obtaining the audio/video signal in the WiFi signal according to the WiFi signal includes: obtaining the audio/video signal in the WiFi signal by using a high-pass/low-pass filter according to the WiFi signal.

Alternatively, the audio/video signal in the TV playing format includes an audio/video signal extracted by half-wave rectification; the sending the converted audio/video signal in the TV playing format to a TV set includes: coupling the extracted audio/video signal to left and right channels and video input terminals of the TV set through a rubber plug, or sending the extracted audio/video signal to the TV set by using a standard video interface and an HDMI interface.

Alternatively, the audio/video signal in the TV playing format includes an audio/video carrier signal played by TV, which is loaded and modulated according to a television system; the sending the converted audio/video signal in the TV playing format to the TV set includes: inserting the audio/video carrier signal into an antenna signal receiving terminal of the TV set, so as to send the converted audio/video carrier signal to the TV set.

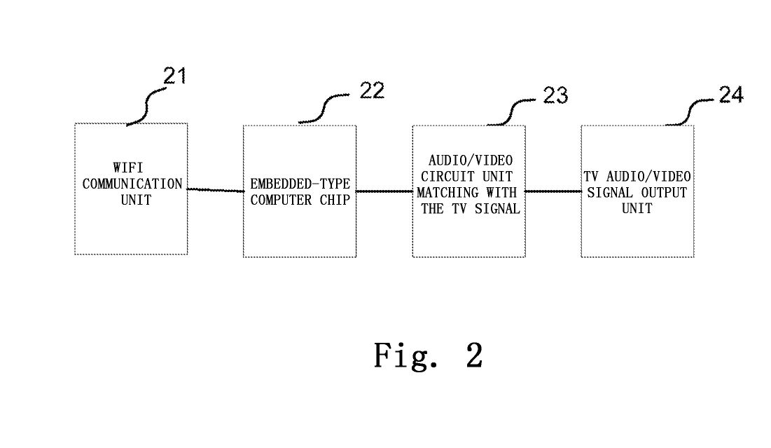

Corresponding to the above method embodiment, as shown in FIG. 2 which is a structural diagram of the apparatus for connecting a TV set to WiFi according to embodiments of the present invention, the apparatus for connecting a TV set to WiFi includes:

a WiFi communication unit 21 for receiving a WiFi signal sent by a WiFi apparatus, the WiFi signal including an audio/video signal;

an embedded-type computer chip 22 for obtaining the audio/video signal in the WiFi signal according to the WiFi signal;

an audio/video circuit unit 23 matching with a TV signal, which is used for converting the audio/video signal into an audio/video signal in a TV playing format; and

a TV audio/video signal output unit 24 for sending the converted audio/video signal in the TV playing format to the TV set.

Alternatively, the WiFi apparatus includes a WiFi router and various intelligent terminals; the WiFi signal further includes a password, the embedded-type computer chip 22 is further used for judging, according to the password, whether the audio/video signal is to be sent to the apparatus.

Alternatively, the embedded-type computer chip 22 is used for obtaining the audio/video signal in the WiFi signal by using a high-pass/low-pass filter according to the WiFi signal.

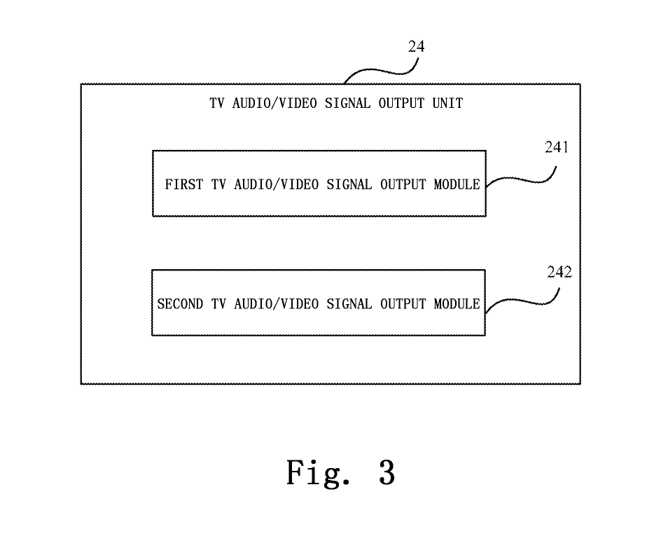

As shown in FIG. 3 which is a structural diagram of a TV audio/video signal output unit according to embodiments of the present invention, the audio/video signal in the TV playing format includes an audio/video signal extracted by half-wave rectification; the TV audio/video signal output unit 24 includes a first TV audio/video signal output module 241 for coupling the extracted audio/video signal to left and right channels and video input terminals of the TV set through a rubber plug, or sending the extracted audio/video signal to the TV set by using a standard video interface and an HDMI interface. Or, the audio/video signal in the TV playing format includes an audio/video carrier signal played by TV, which is loaded and modulated according to a television system; the TV audio/video signal output unit 24 includes a second TV audio/video signal output module 242 for inserting the audio/video carrier signal into an antenna signal receiving terminal of the TV set, so as to send the converted audio/video carrier signal to the TV set.

The technical solutions of the above method and apparatus according to the embodiments of the present invention have the following advantageous effect that it is possible to make all display contents of various video terminals connect to a TV set for display, thereby increasing the use function of the video terminals to a maximum extent, due of the adoption of the technical means of receiving a WiFi signal sent by a WiFi apparatus, the WiFi signal including an audio/video signal; obtaining the audio/video signal in the WiFi signal according to the WiFi signal; converting the audio/video signal into an audio/video signal in a TV playing format; and sending the converted audio/video signal in the TV playing format to a TV set.

The apparatus for converting TV WiFi signal into video signal designed according to the embodiments of the present invention is such an apparatus for connecting a TV set to WiFi. Firstly, in the design of the embodiments of the present invention, the WiFi technology is adopted to realize the purpose of complying with its use environment; secondly, a signal in the format of WiFi is converted into the video signal capable of being play; thirdly, each terminal can be designed with a “key” which can be inserted into different TV sets, with avoiding mutual interference. The embodiments of the invention are intended to make the display contents of various video terminals all connect to a TV set for display by means of the apparatus for connecting a TV set to WiFi, thereby increasing the use function of the video terminals to a maximum extent.

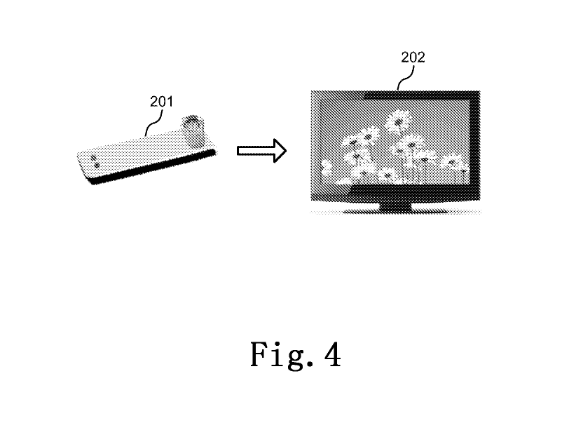

The embodiments of the present invention have the following advantageous effects: a video platform for home and office use in combination with the WiFi router is formed by inserting the apparatus for connecting a TV set to WiFi according to the embodiments of the present invention into a video interface terminal of various TV sets, thereby sharing the display contents (for example, video file contents) of various video terminals at home or offices. The embodiments of the present invention are formed by a built-in software system and a near field wireless communication interface in combination with the mature communication technology, digital technology, network technology and so on. As shown in FIG. 4 which is a diagram of connecting the apparatus for connecting a TV set according to examples of application of the present invention to WiFi with the TV set, a connection is completed by inserting the apparatus 201 for connecting a TV set to WiFi shown in FIG. 4 into the TV set 202. In FIG. 4, the apparatus 201 for connecting a TV set to WiFi is an apparatus according to the application example of the present invention.

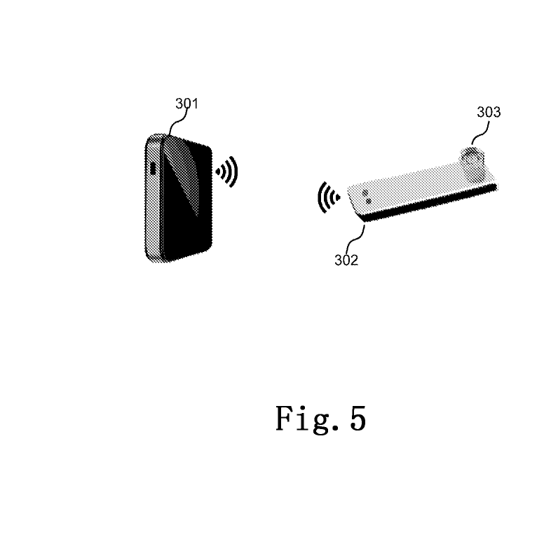

As shown in FIG. 5 which is a diagram of connecting the apparatus for connecting a TV set to WiFi with a WiFi router according to examples of application of the present invention, after a WiFi router 301 is switched on, a connection is completed by inserting a wireless input terminal interface 303 of an apparatus 302 for connecting a TV set to WiFi into the TV set 202.

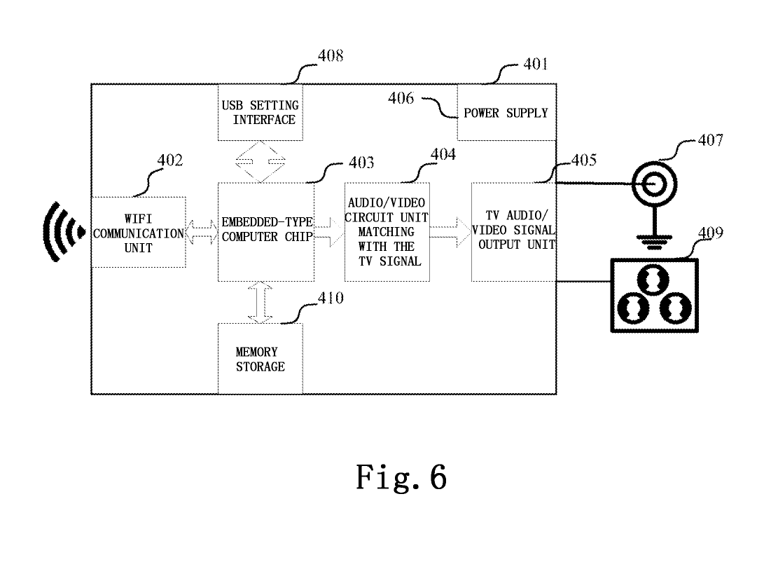

As shown in FIG. 6 which is a diagram of constitutional structure of the apparatus for connecting a TV set to WiFi according to examples of application of the present invention, the apparatus 401 for connecting a TV set to WiFi includes as follows: a WiFi communication unit 402 is a front end for receiving the WiFi signal; when a WiFi signal is input into the WiFi communication unit 402, the WiFi signal is demodulated and then is sent to an embedded-type computer chip 403 for making an judgment for a password of the WiFi signal. If the signal is not to be sent to this apparatus, the next operation is not performed; if the signal is to be sent to this apparatus, the signal is converted according to a playing format by an audio/video circuit unit 404 matching with the TV signal (the playing format can mainly include a TV receiving format, and formats for other terminals are converted into the TV playing formats. Due to different territories and devices of individual country and region, standards of the related formats are different from each other, and the signal is converted correspondingly according to the standards of the territory where the apparatus is used). Because the WiFi signal adopts the transmission frequency of 2.5 G, this apparatus is needed to make conversion. A memory storage 410 is a stack memory used during the conversion process. The converted signal is modulated according to a television system by the audio/video circuit unit 404 matching with the TV signal, and the audio/video signal in the WiFi signal is modulated into a signal, frequency band of which is acceptable by the TV set. Then, the signal is output by a TV audio/video signal output unit 405 (which is an output of the integrated TV). In the diagram of the application example of the present invention shown in FIG. 6, reference number 407 represents a plug-in unit of an input terminal of an antenna, reference number 409 represents rubber plugs which are respectively left and right audio channels and video connectors (reference number 407 indicates an TV antenna coupler, reference number 409 indicates left and right audio channels and video connector coupler). Additionally, in FIG. 6, 406 is a power supply which can be a battery (including a rechargeable battery), or an external power source. 407 in FIG. 6 is the plug-in unit (same as 303 in FIG. 5) matching with the TV set, and 408 in FIG. 6 is a USB setting interface for setting numbers, passwords and names of this apparatus, the settings of which is capable of being made through programs and intelligent terminals.

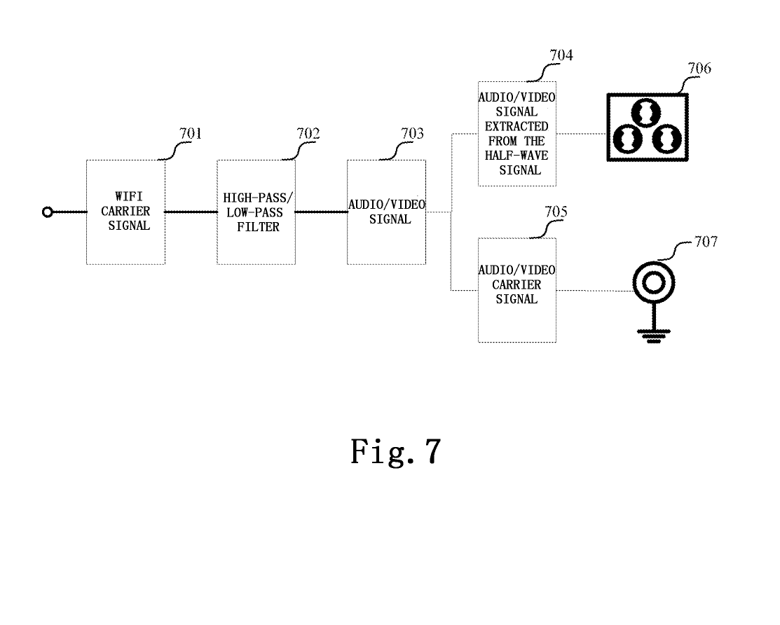

As shown in FIG. 7 which is a logic circuit schematic diagram of the audio/video circuit matching with the TV signal according to the application example of the present invention), after a WiFi carrier signal 701 of 2.5 GHZ is input, an audio/video signal 703 can be extracted by a high-pass/low-pass filter 702. An audio/video signal 704 can be extracted by half-wave rectification, and is connected to left and right channels and video input terminals 706 of the TV set through a rubber plug. Or, by adopting a standard video interface and a HDMI interface, an audio/video carrier signal 705 loaded and modulated into the TV playing format according to different television system is sent to a signal receiving terminal 707 of the TV set.

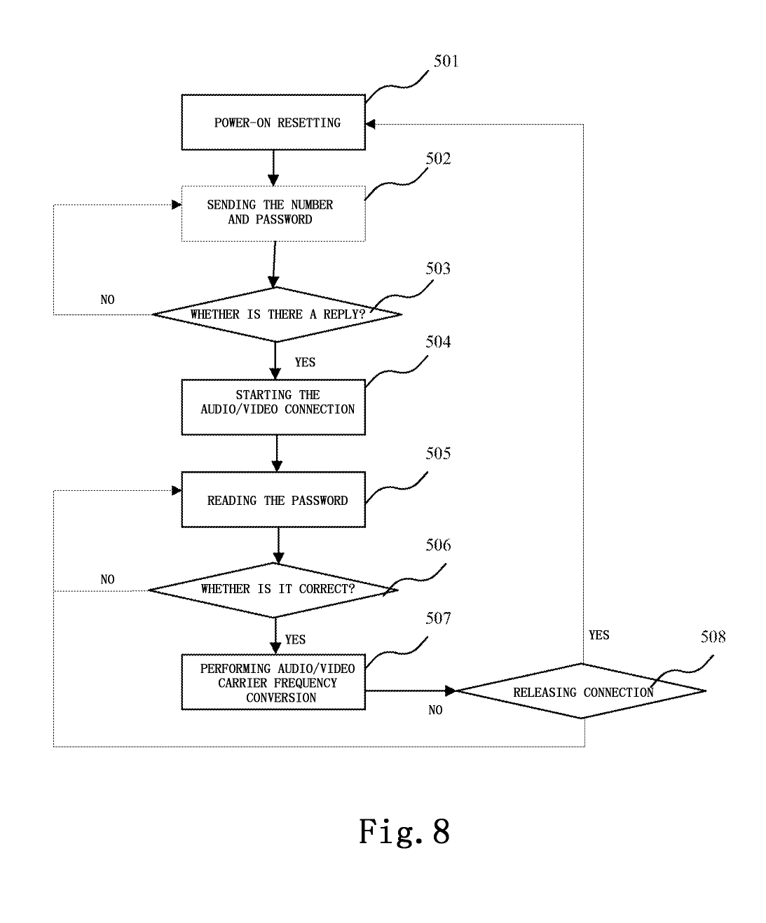

As shown in FIG. 8 which is an operational flow diagram of the apparatus for connecting a TV set to WiFi according to examples of application of the present invention, the flow is as follow:

501. power-on resetting, that is to automatically reset after powering-on, which represents that the program starts running;

502. firstly sending number and password of this apparatus to a platform device so as to seek connection, after the apparatus for connecting a TV set to WiFi operates;

503. judging whether there is a reply: when there is a platform device reply signal representing the completion of connection, then the process proceeds to the step 504; otherwise, the process proceeds to the step 502;

504. starting the audio/video connection after successful connection;

505. reading the password in the WiFi signal when a WiFi signal is sent to here;

506. judging whether the WiFi signal includes an audio/video signal to be sent to this apparatus: if yes, the process proceeds to the step 507, otherwise, the process proceeds to the step 505;

507. performing carrier frequency signal conversion on the audio/video signal;

508. judging whether the connection is released: if yes (for example, such situation mainly occurs when the power supply is weak), the process proceeds to the step 501; otherwise, the process proceeds to the step 505, continuously reading the password in the WiFi signal.

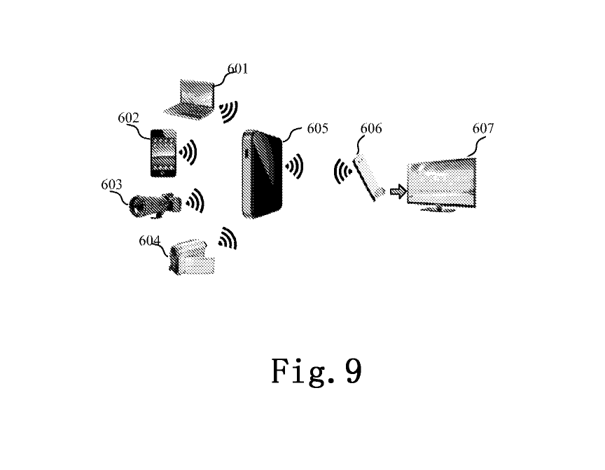

As shown in FIG. 9 which is a diagram of a network architecture formed by the apparatus for connecting a TV set to WiFi through a WiFi router according to examples of application of the present invention, a connection setting network architecture is described. In FIG. 9, reference numbers 601, 602, 603,604 and so on may indicate a WiFi signal source connected with a WiFi router 605, and the playing of the TV set 607 can be realized by format conversion performed by the apparatus 606 for connecting a TV set to WiFi. The network architecture shown in FIG. 9 forms a WIDI (Intel Wireless Display) environment. It is possible to make display contents of various video terminals all connect to the TV set for display, thereby increasing the use function of the video terminals to a maximum extent.

A person skilled in the art will realize that various illustrative logic blocks, units and steps listed in the examples of the present invention can be implemented by electronic hardware, computer software and a combination of the electronic hardware and the computer software. In order to clearly present the interchangeability of hardware and software, the functions of the above various illustrative components, units and steps are commonly described. Whether such functions are implemented by hardware or software is dependent upon the specific application and the design requirement of the whole system. For each specific application, persons skilled in the art can use various methods to implement the function, but such implementation shall not be understood as exceeding the protection scope of the embodiment of the present invention.

Various illustrative logical blocks or units described in the embodiments of the present invention can be implemented or operated to realize the described function through a general-purpose processor, a digital signal processor, an application-specific integrated circuit (ASIC), a Field Programmable Gate Array (FPGA) or other programmable logic devices, discrete gates or transistor logics, discrete hardware parts or the design of any above combinations. The general-purpose processor can be a microprocessor, optionally, the general-purpose processor can also be any traditional processors, controllers, micro-controllers or state machines. The processor can also be realized by the combination of computing devices, such as the digital signal processor and the microprocessor, a plurality of microprocessors, one or a plurality of microprocessors combining with one digital signal processor core, or any other similar configurations.

The steps of the method or algorithm described in the embodiments of the present invention can be embedded into hardware, software module performed by the processor, or the combination of the two. The software module can be stored in RAM storage, flash memory, ROM storage, EPROM storage, EEPROM storage, register, hard disk, removable disk, CD-ROM or the storage mediums in any other forms in the art. Illustratively, the storage medium can be connected with the processor, such that the processor can read information from the storage medium and can write information to the storage medium. Optionally, the storage medium can also be integrated into the processor. The processor and the storage medium can be provided in an ASIC which can be provided in a user terminal. Optionally, the processor and the storage medium can also be provided in different parts of the user terminal.

In one or more illustrative design, the above functions described in the embodiments of the present invention can be implemented by hardware, software, firmware or any combination of the hardware, software and firmware. If implemented in the software, the functions can be stored in the computer-readable medium, or transmitted to the computer-readable medium in the form of one or more instructions or codes. The computer-readable medium includes the computer storage medium and a communication medium enabling the computer program to be transferred to other places from one place. The storage medium can be the available medium which any general-purpose or special computer can access. For example, such computer-readable medium can include, but not limited to, RAM, ROM, EEPROM, CD-ROM or other optical disk storage, magnetic disk storage or other magnetic storage devices, or any other medium capable of carrying or storing the program codes in instructions or data structure and in other form being readable by general-purpose or special computers, or general-purpose or special processors. In addition, any connection can be appropriately defined as the computer-readable medium, for example, if the software is transmitted from one website, server or other remote resources through a coaxial-cable, fiber-optic cable, twisted-pair, digital subscriber line (DSL) or in the wireless way such as infrared, wireless and microwave, it is also included in the defined computer-readable medium. The disk or disc includes a zip disk, a laser disc, an optical disk, DVD, a floppy disk and a blue-ray disc. The disc generally copies data magnetically, and the disk generally optically copies data by laser. The above combination can also be included in the computer-readable medium.

The above embodiments further describe the objects, technical solutions and advantageous effects of the present invention in detail. It should be understood that the above are merely embodiments of the present invention, rather than to restrict the protection scope of the present invention. Any modification, equivalent replacement, improvement within the spirit and principle of the present invention shall be included in the protection scope of the present invention.

What is claimed is:

1. A method for connecting a TV set to WiFi, comprising:
receiving a WiFi signal sent by a WiFi apparatus, the WiFi signal comprising an audio/video signal;
obtaining the audio/video signal in the WiFi signal according to the WiFi signal;
converting the audio/video signal into an audio/video signal in a TV playing format; and
sending the converted audio/video signal in the TV playing format to the TV set.

2. The method for connecting a TV set to WiFi according to claim 1, wherein the WiFi apparatus comprises a WiFi router and an intelligent terminal; the WiFi signal further comprises a password, the method further comprises:
Judging, according to the password, whether the audio/video signal is to be sent to an apparatus for performing the method.

3. The method for connecting a TV set to WiFi according to claim 1, wherein the obtaining the audio/video signal in the WiFi signal according to the WiFi signal comprises:
obtaining the audio/video signal in the WiFi signal by using a high-pass/low-pass filter according to the WiFi signal.

4. The method for connecting a TV set to WiFi according to claim 1, wherein the audio/video signal in the TV playing format comprises an audio/video signal extracted by half-wave rectification;
the sending the converted audio/video signal in the TV playing format to the TV set comprises:
coupling the extracted audio/video signal to left and right channels and video input terminals of the TV set through a rubber plug, or sending the extracted audio/video signal to the TV set by using a standard video interface and an HDMI interface.

5. The method for connecting a TV set to WiFi according to claim 1, wherein the audio/video signal in the TV playing format comprises an audio/video carrier signal played by TV, which is loaded and modulated according to a television system;
the sending the converted audio/video signal in the TV playing format to the TV set comprises:
inserting the audio/video carrier signal into an antenna signal receiving terminal of the TV set, so as to send the converted audio/video carrier signal to the TV set.

6. An apparatus for connecting a TV set to WiFi, comprising:
a WiFi communication unit for receiving a WiFi signal sent by a WiFi apparatus, the WiFi signal comprising an audio/video signal;
an embedded-type computer chip for obtaining the audio/video signal in the WiFi signal according to the WiFi signal;
an audio/video circuit unit matching with a TV signal, for converting the audio/video signal into an audio/video signal in a TV playing format; and
a TV audio/video signal output unit for sending the converted audio/video signal in the TV playing format to the TV set.

7. The apparatus for connecting a TV set to WiFi according to claim 6, wherein the WiFi apparatus comprises a WiFi router and an intelligent terminal; the WiFi signal further comprises a password,
the embedded-type computer chip is further adapted to judge whether the audio/video signal is to be sent to the apparatus according to the password.

8. The apparatus for connecting a TV set to WiFi according to claim 6, wherein
the embedded-type computer chip is adapted to obtain the audio/video signal in the WiFi signal by using a high-pass/low-pass filter according to the WiFi signal.

9. The apparatus for connecting a TV set to WiFi according to claim 6, wherein the audio/video signal in the TV playing format comprises an audio/video signal extracted by half-wave rectification;
the TV audio/video signal output unit comprises a first TV audio/video signal output module for coupling the extracted audio/video signal to left and right channels and video input terminals of the TV set through a rubber plug, so as to send the extracted audio/video signal to the TV set.

10. The apparatus for connecting a TV set to WiFi according to claim 6, wherein the audio/video signal in the TV playing format comprises an audio/video carrier signal played by TV, which is loaded and modulated according to a television system;
the TV audio/video signal output unit comprises a second TV audio/video signal output module for inserting the audio/video carrier signal into an antenna signal receiving terminal of the TV set, so as to send the converted audio/video carrier signal to the TV set.
